(19) United States
(12) Patent Application Publication
(10) Pub. No.: US 2012/0044254 A1
(43) Pub. Date: Feb. 23, 2012

(54) DISPLAY APPARATUS, DISPLAY METHOD AND PROGRAM FOR EXECUTING THE SAME

(76) Inventors: Keiko Watanuki, Osaka (JP); Ikuo Keshi, Osaka (JP)

(21) Appl. No.: 13/266,656

(22) PCT Filed: Apr. 26, 2010
(86) PCT No.: PCT/JP2010/057354

§ 371 Date: Oct. 27, 2011

(30) Foreign Application Priority Data
Apr. 28, 2009 (JP) 2009-109096

(51) Int. Cl. G09G 5/00

(52) U.S. Cl. 345/581

(57) ABSTRACT

An external data detecting portion transmits, when detecting external data such as an incoming call, an incoming detected signal to a load estimating portion. The load estimating portion estimates, when receiving the external data incoming detected signal, a level of a load applied to display of the plurality of video images of a display apparatus by the processing related to the external data. A video image display control portion determines display quality of the video image according to the load level estimated by the load estimating portion to control a video image displayed on a video image display portion. The video image display portion displays a plurality of video images with video image quality controlled by the video image display control portion.

### FIELD OF THE INVENTION

The present invention relates to display of a video image thumbnail list, and relates to a display apparatus, a display method and a program for executing the same for displaying a thumbnail list without applying a load to a device or without putting a stress on a user in displaying a plurality of video images.

### BACKGROUND ART

In reproduction devices (players) and recording and reproduction devices (recorders) of video images, or PCs or the like having a function of recording/reproduction of a video image obtained via broadcast or a network, thumbnail display is frequently used as means to effectively present/manage a number of video images recorded in a recording medium such as a DVD (Digital Versatile Disc), a BD (Blu-ray Disc), an SD memory card, or an HDD (Hard-Disk Drive).

The thumbnail refers to a small image (usually a reduced image of an original image), representing a video image that is displayed instead of the video image, and the thumbnail display refers to a list display form consisting of thumbnails of a plurality of video images (representative reduced images). The thumbnail is usually a still image, however, a so-called moving image thumbnail in which a thumbnail is displayed not by a still image but by a moving image has also been spread gradually in accordance with improvement of a processing capacity of devices. In a case where the processing capacity of a display device is sufficient, in principle, it is possible to display all the thumbnails by moving images.

Patent Literature 1 describes that a user's interest degree is estimated by a difference in displayed states of a plurality of video images displayed on a screen, and that priority of display quality of the video images is determined according to the interest degree. It is also described that by changing display specification of the video image based on the priority, a transfer amount of the video image data or a data amount related to display processing is reduced.

In FIG. 16, a schematic configuration diagram showing a video image display processing system of the Patent Literature 1 is shown. This video image display processing system is comprised of a video image input portion 301 which incorporates a video image into a system, a display apparatus 200 which displays the incorporated video image, and a communication network 300 which communicates various data by interconnecting a video image input portion 301 and the display apparatus 200. The display device 200 is comprised of a transmission/reception portion 201, a video image display portion 204, a video image display control portion 205, a display state management table 206, and an interest degree measuring portion 207.

The video image display control portion 205 stores display state data of each displayed video image in the display state management table 206. The interest degree measuring portion 207 estimates a user's interest degree of each video image based on the display state data. The video image display control portion 205 changes a display specification of each video image so as to display a video image in which a high degree of interest is taken with high display quality and to display a video image in which a low degree of interest is taken with reduced display quality, to be transferred from the transmission/reception portion 201 to the video image input portion 301 via the network 300. The video image input portion 301 controls the input video image data to be compressed based on the changed display specification, and the video image data is transmitted to the display device 200 via the network 300.

That is, the configuration of the Patent Literature 1 is characterized in that, the display specification of each video image is changed from the displayed state of the video images on the screen, and the video image data is compressed by the video image input portion 301, so that the transfer amount of the video image data or the data amount related to the display processing is reduced.

Patent Literature 2 describes that in a video on-demand apparatus, when a telephone function is executed while executing a video on-demand function, reproduction of a programs is temporarily stopped so as to prevent the program from being unable to be viewed due to the telephone function. It is also described that after finishing the telephone function, the temporary stop of the program is released so as to restart the reproduction from the stopped position.

### KNOWN ART LITERATURES

### Patent Literature

Patent Literature 1: Japanese Patent Application Laid-open No. 6-324662
Patent Literature 2: Japanese Patent Application Laid-open No. 7-327221

### SUMMARY OF THE INVENTION

### Problems to be Solved by the Invention

With the technology of Patent Literature 2, when viewing a video image, viewing may be interrupted by an incoming call, an incoming mail, and the like, and as a method for dealing these interruptions, interruption or finishing of viewing of the video image may be performed. However, there is a need for talking with a friend on a phone while looking at thumbnail display, and reproduction is required without interrupting or finishing reproduction of the video image even though an incoming call is received.

Further, with the technology of Patent Literature 1, in a system which a display apparatus is connected to a communication network and data is transmitted via the Net, it is conceivable that while viewing video image data, reception of a video image stream or the like occurs so that the number of video images to be displayed on the display apparatus increases. In such a case, the device is applied with a load for processing these additional video images, thus having a possibility to influence the display of the video image in currently being viewed, however, in Patent Literature 1, such a situation is not assumed.

Moreover, in Patent Literature 1, although the display specification of the video image is determined on a side of the display apparatus, it is configured that the specification is transferred to a video image input portion via the Net, and after compressing the video image data, it is transmitted again to the display device via the Net, therefore, it is desired that processing is finished only on the side of the display apparatus.

Meanwhile, the present invention is devised in view of the above-described problem, and provides a display apparatus, a display method and a program for executing the same capable of continuing reproduction without interrupting or finishing moving image display of a plurality of thumbnails in currently being viewed, even when external data different from video image data in being viewed is input.

### Means to Solve the Problems

The present invention provides a display apparatus for controlling display quality of a plurality of video image data to be displayed, including: data detecting means for detecting an input of data different from video image data being displayed; load estimating means for estimating a load applied to a processing capacity of the display apparatus by the different data; and video image display control means for changing, in a case where the load exceeds the processing capacity of the display apparatus, quality of a plurality of video images to be displayed on the display apparatus so that display processing is able to be continued.

Here, the different data is characterized by being external data which is data other than the video image. This display apparatus further includes processing delay means for delaying, when reception of the external data is detected by the data detecting means, processing of the external data by a predetermined time.

Furthermore, the different data is characterized by being different video image data which is displayed additionally to the video image data being displayed. This display apparatus further includes processing delay means for delaying processing of the external data by a predetermined time when reception of the different video image data is detected by the data detecting means.

Further, the present invention provides a display apparatus for controlling display quality of a plurality of video image data to be displayed, including: video image detecting means for detecting video image data which is displayed additionally to display video image data; external data detecting means for detecting an input of external data which is data different from the video image data; load estimating means for estimating a load applied to display of a plurality of video images displayed on the display apparatus by the additional video image data and/or the external data; and video image display control means for changing, in a case where the load exceeds the processing capacity of the display apparatus, quality of a video image to be displayed on the display apparatus so that display processing is able to be continued.

This display apparatus further includes: display delay means for delaying, when an input of the additional video image is detected by the video image detecting means, display of the additional video image by a predetermined time; and processing delay means for delaying, when reception of the external data is detected by the external data detecting means, processing of the external data by a predetermined time.

Furthermore, the display apparatus of the present invention is characterized in that the video image display control means changes the display quality by switching into real-time reproduction, slow reproduction, or skip reproduction according to a load level estimated by the load estimating means.

Furthermore, the display apparatus of the present invention is characterized in that the video image display control means changes the display quality by simplifying decoding processing within an allowable range of image quality deterioration according to a load level estimated by the load estimating means.

Furthermore, in the display apparatus of the present invention, the video image display control means may switch the display quality of all the video images simultaneously, may change the display quality for a video image other than a video image to which a user pays attention, or may change the display quality only for a video image which is newly added.

Furthermore, the display apparatus of the present invention is characterized in that the video image display control means has a function to give a notice to a user about a change in the display quality of a video image during delay.

The present invention provides a display method for controlling display quality of a plurality of video image data to be displayed on a display apparatus, including: a data detecting step of detecting an input of data different from video image data being displayed;

a load estimating step of estimating a load applied to a processing capacity of the display apparatus by the different data; and

a video image display control step of changing, in a case where the load exceeds the processing capacity of the display apparatus, quality of a plurality of video images to be displayed on the display apparatus so that display processing is able to be continued.

Here, the different data is characterized by being external data which is data other than the video image. This display method further includes a processing delay step of delaying, when reception of the external data is detected by the data detecting step, processing of the external data by a predetermined time.

Furthermore, the different data is characterized by being different video image data which is displayed additionally to the video image data being displayed. This display method further includes a processing delay step of delaying, when reception of the different video image data is detected at the data detecting step, processing of the different video image data by a predetermined time.

Further, the present invention provides a display method for controlling display quality of a plurality of video image data to be displayed, including: a video image detecting step of detecting video image data which is displayed additionally to display video image data; an external data detecting step of detecting an input of external data which is data different from the video image data; a load estimating step of estimating a load applied to display of a plurality of video images displayed on the display apparatus by the additional video image data and/or the external data; and a video image display control step of changing, in a case where the load exceeds the processing capacity of the display apparatus, quality of a video image to be displayed on the display apparatus so that display processing is able to be continued.

This display method further includes: a display delay step of delaying, when an input of the additional video image is detected by the video image detecting step, display of the additional video image by a predetermined time; and a processing delay step of delaying, when reception of the external data is detected by the external data detecting step, processing of the external data by a predetermined time.

Furthermore, the display method of the present invention is characterized in that at the video image display control step, the display quality is changed by switching into real-time reproduction, slow reproduction, or skip reproduction according to a load level estimated by the load estimating means.

Furthermore, the display method of the present invention is characterized in that at the video image display control step, the display quality is changed by simplifying decoding processing within an allowable range of image quality deterioration according to a load level estimated by the load estimating means.

Furthermore, in the display method of the present invention, at the video image display control step, the display quality of all the video images may be switched simultaneously, the display quality for a video image other than a video image to which a user pays attention may be changed, or the display quality only for a video image which is newly added may be changed.

Furthermore, the display method of the present invention is characterized in that at the video image display control step, a function to give a notice to a user about a change in the display quality of a video image during delay is provided.

Further, the present invention provides a program for causing a computer to execute the display method.

### Effect of the Invention

According to the present invention, even when external data such as an incoming call or the like is received, or even when an additional video image is input, reproduction is able to be continued without interrupting or finishing reproduction of a plurality of video images in currently being viewed and a user is able to operate the a device without any stress.

Additionally, display quality of a plurality of video images of a display apparatus according to a reception state of the external data or the additional video image is changed, thereby making it possible to effectively display a plurality of video images corresponding to a processing capacity of a device.

Moreover, processing of the actual external data and the additional video image is delayed by a predetermined time, and meanwhile (before an increase of a CPU load), the display quality of the video image of the display apparatus is changed, thereby enabling display of a plurality of video images corresponding to the processing capacity of the device.

Further, the reproduction of the plurality of video images is switched into real-time (actual time) reproduction, slow reproduction, or skip reproduction according to a level of a load applied to the display of the plurality of video images by the video image or the external data, thereby enabling display of the plurality of video images corresponding to the processing capacity of the device.

### BRIEF DESCRIPTION OF THE DRAWINGS

FIG. 1 is a block configuration diagram of a display apparatus in a first embodiment;

FIG. 2 is an explanatory view showing a thumbnail display example in a video image display portion;

FIG. 3 is a flowchart showing processing procedure of the display apparatus in the first embodiment;

FIG. 4 is an explanatory view showing an example of a display quality management table;

FIG. 5 is a block configuration diagram of a display apparatus in a second embodiment;

FIG. 6 is a flowchart showing processing procedure of the display apparatus in the second embodiment;

FIG. 7 is a block configuration diagram of a display apparatus in a third embodiment;

FIG. 8 is an explanatory view showing a display example when a video image is added;

FIG. 9 is a flowchart showing processing procedure of the display apparatus in the third embodiment;

FIG. 10 is a block configuration diagram of a display apparatus in a fourth embodiment;

FIG. 11 is a flowchart showing processing procedure of the display apparatus in the fourth embodiment;

FIG. 12 is a block configuration diagram of a display apparatus in a fifth embodiment;

FIG. 13 is a flowchart showing processing procedure of the display apparatus in the fifth embodiment;

FIG. 14 is a block configuration diagram of a display apparatus in a sixth embodiment;

FIG. 15 is a flowchart showing processing procedure of the display apparatus in the sixth embodiment; and

FIG. 16 is a schematic configuration diagram of a video image information processing system of a conventional art (Patent Literature 1).

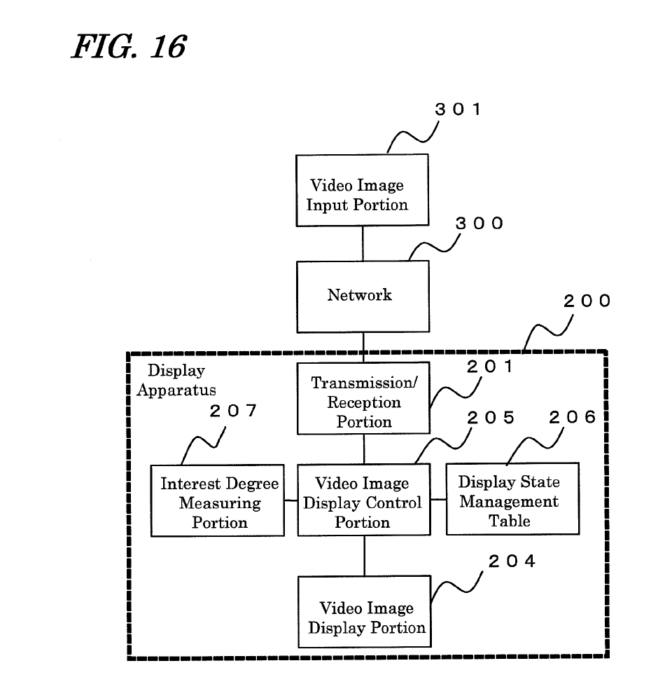

### MODE FOR CARRYING OUT THE INVENTION

Hereinafter, description will be given for embodiments of the present invention with reference to accompanying drawings.

### First Embodiment

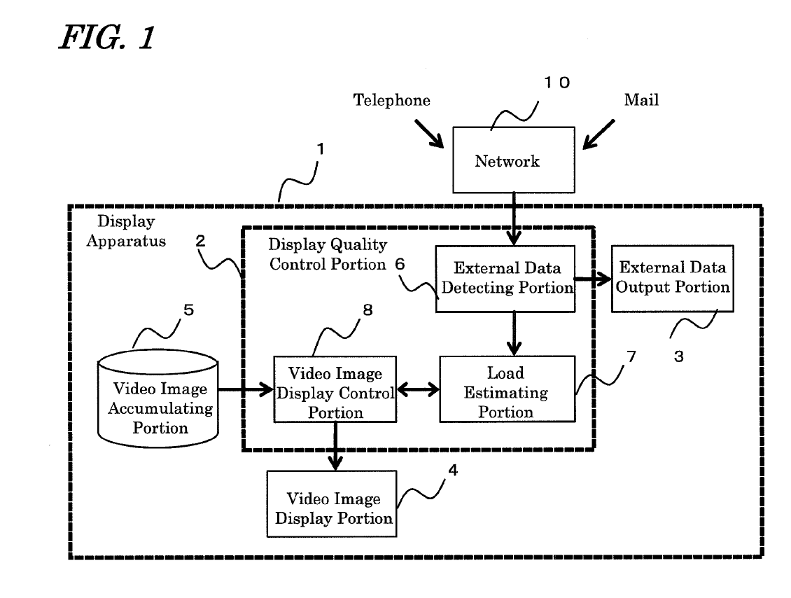

As an embodiment, here, a display apparatus 1 configured to be applied to a communication device such as a mobile phone with a display apparatus is taken as an example, and description thereof is given. The configuration of the present application is shown in FIG. 1. The display apparatus 1 includes a display quality control portion 2, an external data output portion 3, a video image display portion 4, as well as a video image accumulating portion 5. The display quality control portion 2 is comprised of an external data detecting portion 6, a load estimating portion 7, and a video image display control portion 8. On the basis of this drawing, description will be given for each portion constituting the display apparatus 1.

The display apparatus 1 according to the present embodiment is characterized by having the display quality control portion (display quality control means) 2 so that, in so-called moving image thumbnail display in which thumbnails displayed as a list are displayed by moving images, for example, when external data such as a telephone or a mail different from display video image data is input, a plurality of video images being displayed on a screen are allowed to be continued to be displayed without interrupting or finishing. Detailed description will be given below for a function of the display quality control portion 2.

(Function of Display Quality Control Portion)

The external data detecting portion (external data detecting means) 6 detects an input of external data such as an incoming call or mail from a network 10 via a communication function to the display apparatus 1. For example, when an incoming call is detected, an incoming detected signal is transmitted to the load estimating portion 7.

The load estimating portion 7 estimates, when receiving the external data incoming detected signal, a level of a load applied to display of a plurality of video images by the processing related to the external data. The load at this time is a total load to a CPU (not shown) of the display apparatus 1 that is estimated from a processing amount required for display of a plurality of video images, a processing amount of the external data, and a battery remaining amount of the display apparatus 1.

The video image display control portion (video image display control means) 8 determines display quality of all the video images displayed on the display apparatus 1 according to the load level estimated by the load estimating portion (load estimating means) 7, and controls reproduction of each thumbnail video image displayed on a screen at the video image display portion 4 (in the case of encoded data, decoding processing is included) and arrangement of the thumbnails on the screen. For example, when the load level is increased, a frame rate or resolution of the video image is reduced, a compression rate is increased, or decoding processing is simplified. As a method for simplifying the decoding processing, simplification of motion compensation, omission of a deblocking filter, frame skip, and the like are included. In the present embodiment, it is characterized in that the display quality of a video image is determined to be any of real-time (actual time) reproduction, slow reproduction, or skip reproduction according to a load level estimated by the load estimating portion 7, and for each of which, reproduction processing and arrangement required are controlled. The detail thereof will be described below.

The video image display control portion (video image display control means) 8 may also perform change of the display quality only for a video image other than a video image to which a user pays attention. The video image to which a user pays attention is, for example, a video image on the display apparatus 1 on which a cursor or the like is placed, a video image which is displayed in the center of a screen of the display apparatus 1, or a video image which is selected by a user operation.

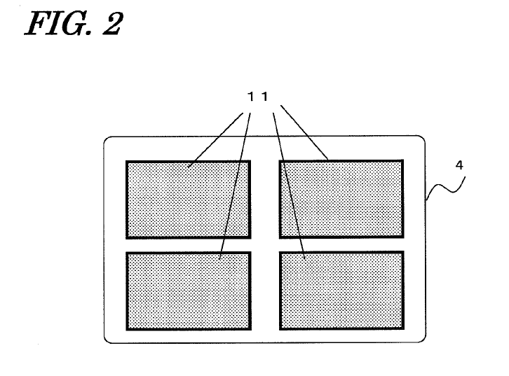

The video image display portion (video image display means) 4 is comprised of, for example, a liquid crystal panel, and displays as a thumbnail a video image of the video image accumulating portion 5, or a video image in an external memory, although not shown, connected to the display apparatus 1, or a video image distributed via the network 10 with video image quality and an arrangement which have been determined by the video image display control portion 8. FIG. 2 is a view showing an example in which a plurality of video images (thumbnails) are displayed at the video image display portion 4 of the display apparatus 1. In the present example, four sheets of video images 11 are displayed. The plurality of video images 11 are continued to be displayed without disappearing, even at the time of receiving an incoming call or mail.

The external data output portion (external data output means) 3 executes processing of external data which has been detected by the external data detecting portion 6, for example, processing such as ringing of an incoming call.

In the present embodiment, although description is given for the display control function of the thumbnail video image, in an actual display apparatus, other than the thumbnail video image, for example, reproduction of one video image, or displaying a three-dimensional video image or a still image such as a picture or the like may also occur, therefore, it is needless to say that the function of the present embodiment is also applicable during such video image display (reproduction). In this respect, same applies to other embodiments.

(Processing Flow of Display Quality Control Portion)

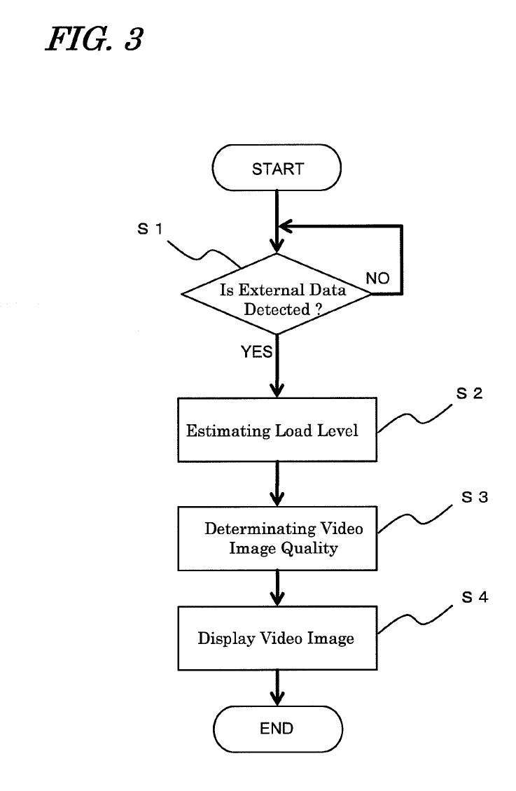

Next, a processing flow in the display apparatus 1 will be described. FIG. 3 is a flowchart showing processing procedure of the display apparatus 1 in the first embodiment.

Assume that a user is browsing a plurality of video images (thumbnails) as a display example shown in FIG. 2 with the display apparatus 1. At this time, the external data detecting portion 6 is in a standby state of detection (step S1: hereinafter, step is omitted). When the external data detecting portion 6 detects external data such as an incoming call or the like (YES at S1), an incoming detected signal is transmitted to the load estimating portion 7. The load estimating portion 7 estimates, when receiving the external data incoming detected signal, a level of a load applied to display of the plurality of video images of the display apparatus 1 by the processing related to the external data (S2). The video image display control portion 8 determines display quality of the video image according to the load level estimated by the load estimating portion 7 and controls a video image displayed at the video image display portion 4 (S3). The video image display portion 4 displays a plurality of video images with video image quality determined by the video image display control portion 8 (S4), and the processing is finished.

(Video Image Display Control)

Next, description will be given for a method of video image display control.

The video image display control portion (video image display control means) 8 determines the display quality of the video image according to the load level estimated by the load estimating portion (load estimating means) 7, and controls reproduction of each thumbnail video image displayed on the screen at the video image display portion (in the case of encoded data, decoding processing is included) and arrangement of the thumbnails on the screen. Here, description will be given for a method in which the display quality of a video image is determined to be any of real-time (actual time) reproduction, slow reproduction, or skip reproduction according to the load level estimated by the load estimating portion 7, and for each of which, reproduction processing and arrangement required are controlled.

Assume that a user is browsing a plurality of video images (thumbnails) as a display example shown in FIG. 2 with the display apparatus 1. At this time, assuming that an incoming call which is the external data is received, a CPU of the display apparatus 1 is required to process both display of the plurality of video images 11 and the telephone function. Further, in a case where the display apparatus 1 is driven by a battery like mobile phones, a load to the CPU depends on also a capacity of the battery.

Then, the load estimating portion 7 estimates a level of a load applied to the CPU of the display apparatus 1 from a processing amount required for display of a plurality of video images currently being displayed, a processing amount required for executing the external data, and a battery remaining amount of the display apparatus.

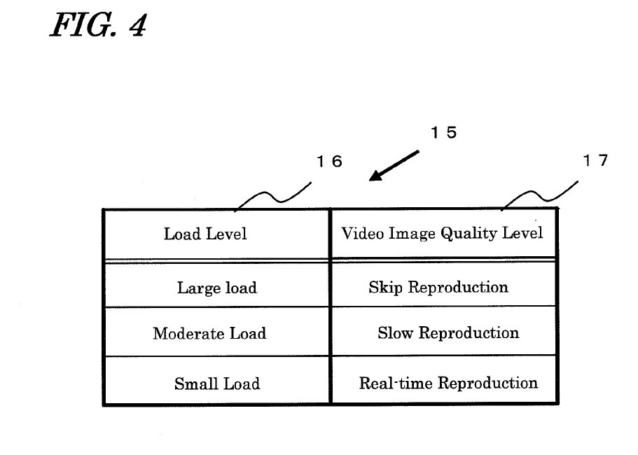

The video image display control portion (video image display control means) 8 includes a display quality management table 15 as shown in FIG. 4, and determines the video image quality level 17 to be any of real-time (actual time) reproduction, slow reproduction, or skip reproduction according to a load level 16 estimated by the load estimating portion (load estimating means) 7.

Here, “small load” is a case where an impact on video reproduction is judged to be small since the load level is small, accordingly, the quality of the video image which has been browsed by the user so far is not changed, and is continued to be real-time (actual time) reproduction. “Moderate load” is a case where an impact on video reproduction is judged to be moderate, and accordingly, the quality of the video image which has been browsed by the user so far is controlled to be slow reproduction, for example, ½ speed reproduction. “Large load” is a case where an impact on video reproduction is judged to be large, and in this case, the quality of the video image which has been browsed by the user so far is controlled to perform skip reproduction, for example, to reproduce only I picture.

Note that, in the present embodiment, it is configured to change the video image quality in this order of real-time reproduction→slow reproduction→skip reproduction as the load level increases, and this is based on that as a result of a subjective assessment experiment by viewers for reproduction of a plurality of video images, user's tolerance is resulted in this order. Note that, both the type and the change order of the video image quality are not limited thereto.

In the present embodiment, description has been given for the display control function when external data different from the video image data in being viewed is input, however, it is needless to say that finishing of input of the external data (hang up the phone, for example) is also detected by the external data detecting portion 6 shown in FIG. 1 so that a video image is displayed with optimum video image quality at the time point according to the flowchart of FIG. 3 (namely, returning to the original display quality). In this respect, same applies to other embodiments.

In this manner, in the first embodiment, when external data is received, a processing load applied to the display apparatus is estimated and display quality of a video image is changed so as to enable reduction in the processing load on the display apparatus as well as reproduction of the video image to be continued without interrupting or finishing.

### Second Embodiment

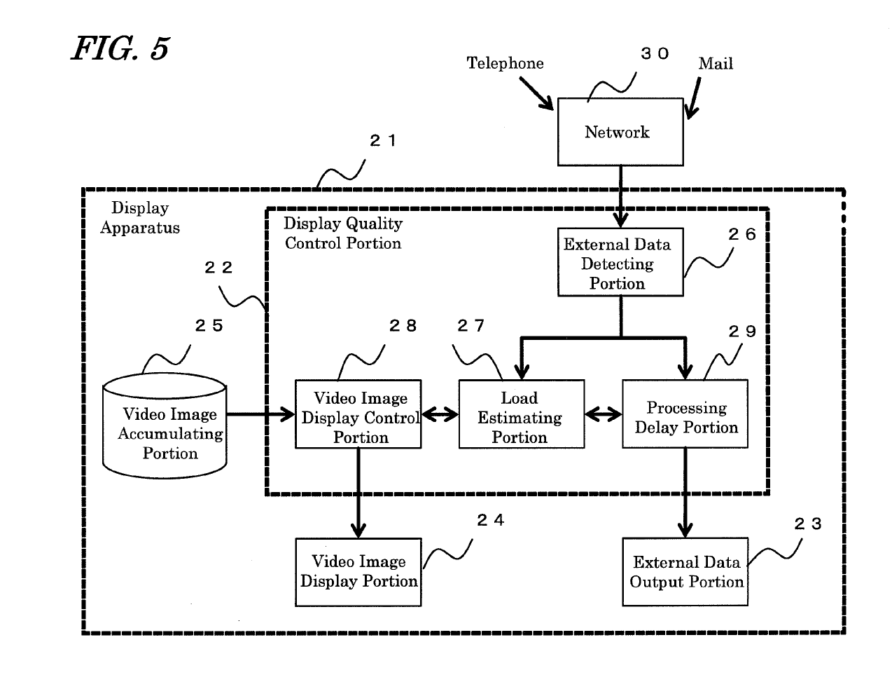

The configuration of the display apparatus of the second embodiment is shown in FIG. 5. The display apparatus 21 includes a display quality control portion 22, an external data output portion 23, a video image display portion 24, as well as a video image accumulating portion 25. The display quality control portion 22 includes an external data detecting portion 26, a load estimating portion 27, a video image display control portion 28, and a processing delay portion 29.

The display apparatus 21 in the second embodiment is comprised of the processing delay portion 29, in addition to the configuration of the first embodiment. Thereby, actual external data processing (such as ring a bell of a telephone) is delayed by a predetermined time, and meanwhile (before an increase of a CPU load), the display quality of the video image displayed on the display apparatus 21 is changed, and display of a plurality of video images corresponding to the processing capacity of the device is thereby able to be performed.

Description will be given in detail below for the function of the display quality control portion 22 in the second embodiment.

(Function of Display Quality Control Portion)

The external data detecting portion (external data detecting means) 26 detects an input of external data such as an incoming call or mail via a communication function to the display apparatus 21. For example, when an incoming call is detected, an incoming detected signal is transmitted to the processing delay portion 29 and the load estimating portion 27.

The processing delay portion (processing delay means) 29 delays, when receiving the external data incoming detected signal, by a predetermined time the processing of external data which has been detected, for example, incoming call processing (such as ringing of an incoming call). The delay time may be set in advance, or may be delayed until a video image is displayed on the video image display portion 24 shown below.

The load estimating portion (load estimating means) 27 estimates, when receiving the external data incoming detected signal, a level of a load applied to display of a plurality of video images by the processing related to the external data. The load at this time is a total load to a CPU of the display apparatus 21 that is estimated from a processing amount required for display of a plurality of video images, a processing amount of the external data, and a battery remaining amount of the display apparatus 21.

The video image display control portion (video image display control means) 28 determines display quality of the video image according to the load level estimated by the load estimating portion (load estimating means) 27, and controls reproduction of each thumbnail video image displayed on the screen at the video image display portion 24 (in the case of encoded data, decoding processing is included) and arrangement of the thumbnails on the screen. For example, when the load level is increased, a frame rate or resolution of the video image is reduced, a compression rate is increased, or decoding processing is simplified. As a method for simplifying the decoding processing, simplification of motion compensation, omission of a deblocking filter, frame skip, and the like are included. In the present embodiment, it is characterized in that the display quality of a video image is determined to be any of real-time (actual time) reproduction, slow reproduction, or skip reproduction according to a load level estimated by the load estimating portion 27, and for each of which, reproduction processing and arrangement required are controlled. The detail thereof is the same as the first embodiment.

The video image display control portion (video image display control means) 28 may also have a display timing control function so that all the plurality of video images are switched into the display quality simultaneously after delaying the processing.

The video image display control portion (video image display control means) 28 may also perform a change of the display quality only for a video image other than a video image to which a user pays attention. The video image to which a user pays attention is, for example, a video image on the display apparatus on which a cursor or the like is placed, a video image which is displayed in the center of a screen of the display apparatus, or a video image which is selected by a user operation.

Further, the video image display control portion (video image display control means) 28 may have a function to give a notice to a user about a change in the display quality of a video image during delay of the processing. For example, before changing the display quality, a text (character) may be displayed around the video image with the display quality to be changed, or video image effect may be displayed such as illuminating a frame of the video image with the display quality to be changed, so as to give a notice to a user.

The video image display portion (video image display means) 24 is comprised of, for example, a liquid crystal panel, and displays as a thumbnail a video image of the video image accumulating portion 25, or a video image in an external memory, although not shown, connected to the display apparatus 21, or a video image distributed via the network 30 with video image quality and an arrangement which have been determined in the video image display control portion 28.

The external data output portion (external data output means) 23 executes processing of external data which has been delayed by the processing delay portion 29, for example, processing such as ringing of an incoming call.

(Processing Flow of Display Quality Control)

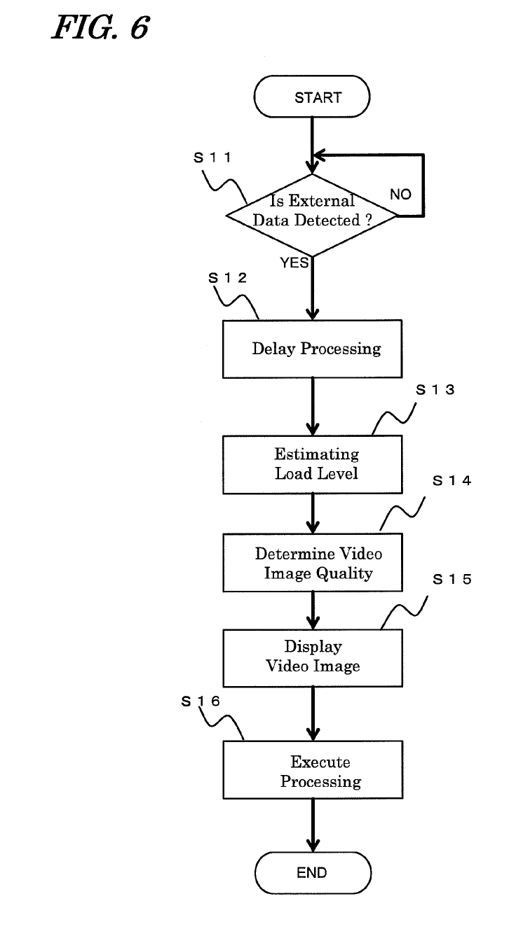

Next, description will be given for a processing flow in the display apparatus 21 in the second embodiment. FIG. 6 is a flowchart showing processing procedure of the display apparatus 21 in the second embodiment.

Assume that a user is browsing a plurality of video images (thumbnails) as a display example shown in FIG. 2 with the display apparatus 21. At this time, the external data detecting portion 26 is in a standby state of detection (S11). When the external data detecting portion detects external data such as an incoming call or the like (YES at S11), an incoming detected signal is transmitted to the processing delay portion 29 and the load estimating portion 27. The processing delay portion 29 delays, when receiving the external data incoming detected signal, by a predetermined time incoming call processing (such as ringing of an incoming call) (S12). The load estimating portion 27 estimates, when receiving the external data incoming detected signal, a level of a load applied to display of the plurality of video images of the display apparatus by the processing related to the external data (S13). Note that, in this processing flow, estimation of the load level is performed after delaying the processing, however, the estimation of the load level may be performed, thereafter the processing may be delayed, or alternatively, both the processing may be performed simultaneously.

The video image display control portion 28 determines display quality of the video image according to the load level estimated by the load estimating portion 27 and controls a video image displayed on the video image display portion 24 (S14). The video image display portion 24 displays a plurality of video images with video image quality controlled by the video image display control portion 28 (S15). After the elapse of a predetermined time, the external data output portion 23 executes processing of external data such as incoming call processing (such as ringing of an incoming call) (S16), and the processing is finished.

Note that, in the present processing flow, the processing delay at S12 is set to a predetermined time, and the processing execution at S16 is after the elapse of a predetermined time. However, a time of the processing delay at S12 may not be set, and although not shown in FIG. 6, the delay time may be determined at S13 according to the load level estimated by the load estimating portion 27, or alternatively, a flow may be provided for judging whether or not the video image display at S15 is finished, and the process may shift to processing execution at S16 when the video image display is finished.

In this way, in the second embodiment, the processing delay portion 29 of the external data is provided and whereby, the incoming call processing or the like (such as ringing of an incoming call) is delayed by a predetermined time, and meanwhile (before an increase of a CPU load), the display quality of the video image of the display apparatus is changed, thereby enabling display of a plurality of video images corresponding to the processing capacity of the device.

### Third Embodiment

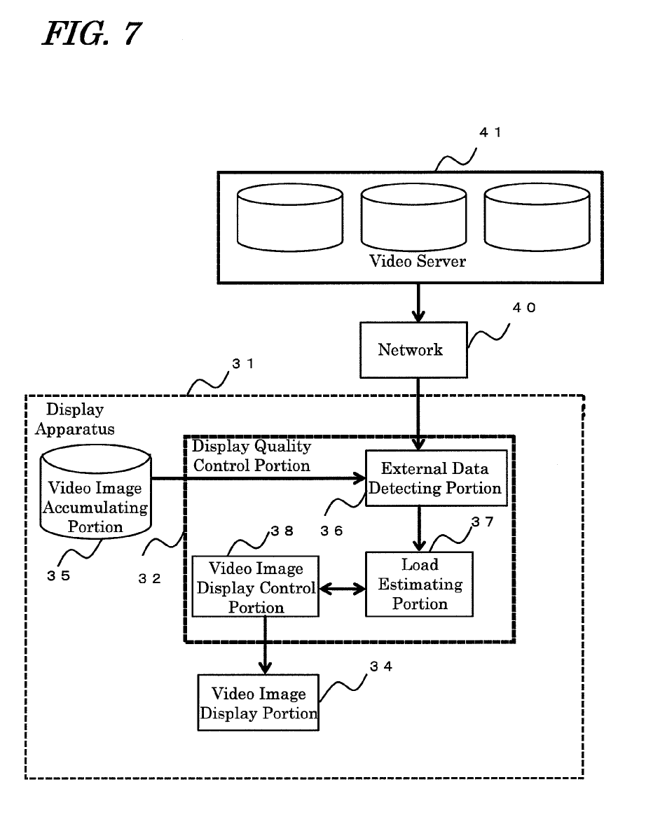

Hereinafter, as an embodiment, description will be given as an example for a display apparatus 31 configured to be applied to a communication device such as a mobile phone with a display apparatus. The configuration of the present application is shown in FIG. 7, and on the basis of the drawing, description will be given for each portion constituting the display apparatus 31.

The display apparatus 31 includes a display quality control portion 32, a video image display portion 34, as well as a video image accumulating portion 35. The display quality control portion 32 includes a video image detecting portion 36, a load estimating portion 37 and a video image display control portion 38.

In the third embodiment, as shown in FIG. 7, in addition to the video image accumulating portion 35 incorporated in the display apparatus 31, a plurality of video images are able to be distributed from a video server 41 to the display apparatus 31, and it is aimed to control, when video image data is added from the video image accumulating portion 35 and/or the video server 41 to the display apparatus 31 on which a video image is currently displayed, so that the display quality of the video image which is currently displayed or a video image to be added is changed so as not to exceed the display processing capacity of the display apparatus 31. Note that, although not shown in FIG. 7, a video image in an external memory connected to the display apparatus 31 may be incorporated therein.

(Function of Display Quality Control Portion)

The video image detecting portion (video image detecting means) 36 detects an input of video image data from the video image accumulating portion 35 or from the video server 41 via a network 40, and transmits a detected signal to the load estimating portion 37.

The load estimating portion (load estimating means) 37 estimates, when receiving the video image incoming detected signal, a level of a load applied to display of a video image currently being displayed by the processing related to the display of the additional video image. The load at this time is a total load to a CPU of the display apparatus 31 that is estimated from a processing amount required for display of the current video image, a processing amount required for display of the additional video image and a battery remaining amount of the display apparatus 31. For example, in a case where, when three video images are displayed, different three video images are received, a load level of the CPU of the display apparatus 31 is estimated from the processing amount required for the reproduction processing for a total of six video images, the battery remaining amount of the display apparatus 31 and the like. Note that, the processing amount required for the display of the plurality of the video images depends on the number of pieces of video images displayed on the screen, a size of each video image, the number of frame rates, the resolution and the like.

The video image display control portion (video image display control means) 38 determines display quality of all the video images (the video image currently being displayed and the video image to be added) according to the load level estimated by the load estimating portion (load estimating means) 37, and controls reproduction of each thumbnail video image displayed on the screen at the video image display portion (in the case of encoded data, decoding processing is included) and arrangement of the thumbnails on the screen. For example, when the load level is increased, a frame rate or resolution of all the video images is reduced, a compression rate is increased, or decoding processing is simplified. As a method for simplifying the decoding processing, simplification of motion compensation, omission of a deblocking filter, frame skip, and the like are included. In the third embodiment, as with the first embodiment, the display quality management table 15 as shown in FIG. 4 is provided, and the video image quality level 17 is determined to be any of real-time (actual time) reproduction, slow reproduction, or skip reproduction according to the load level 16 estimated by the load estimating portion 37.

Here, “small load” is a case where an impact on video reproduction is judged to be small since the load level is small like a low quality video image of One Seg or the like, accordingly, the quality of the video image which has been browsed by the user so far is not changed, and is continued to be real-time (actual time) reproduction. “Moderate load” is a case where an impact on video reproduction is judged to be moderate, accordingly, the quality of the video image which has been browsed by the user so far is controlled to be slow reproduction, for example, ½ speed reproduction, so that the load is reduced to ½. “Large load” is a case where an impact on video reproduction is judged to be large like a high pixel/high frame rate video image, and in this case, the quality of the video image which has been browsed by the user so far is controlled to perform skip reproduction, for example, to reproduce only I picture, so that the load is reduced to one several tenth.

The video image display control portion (video image display control means) 38 may also have a function to perform change of the display quality only for a video image other than a video image to which a user pays attention. The video image to which a user pays attention is, for example, a video image on the display apparatus 31 on which a cursor or the like is placed, a video image which is displayed in the center of a screen of the display apparatus, or a video image which is selected by a user operation.

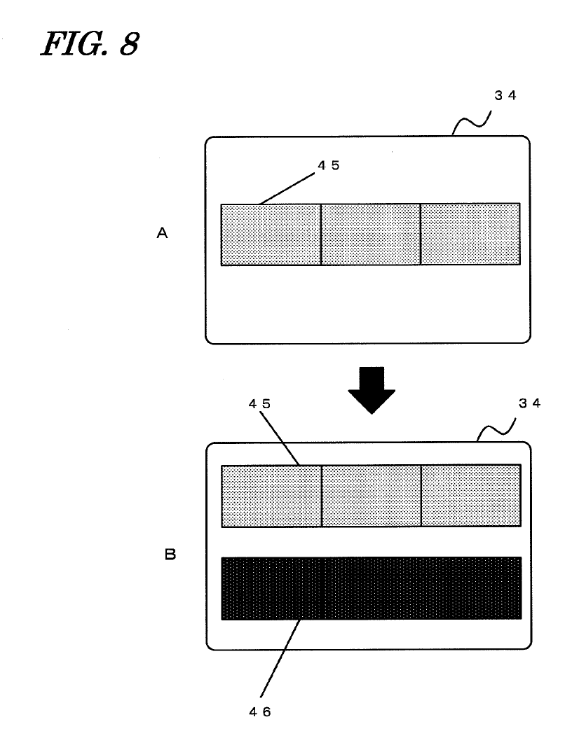

Further, the video image display control portion (video image display control means) 38 may have a function to perform change of the display quality only for an additional video image. For example, as shown in FIG. 8A, three video images 45 are displayed on the video image display portion 34. In a case where, adding to the video images 45, three video images 46 are added to become FIG. 8B, assuming that the lower three are the additional video images 46, the display quality of the lower three video images 46 is only changed.

The video image display portion (video image display means) 34 is comprised of, for example, a liquid crystal panel, and displays as a thumbnail all the video images (the video images currently being displayed and the additional video images) with video image quality and an arrangement which have been determined in the video image display control portion 38.

(Processing Flow of Display Quality Control Portion)

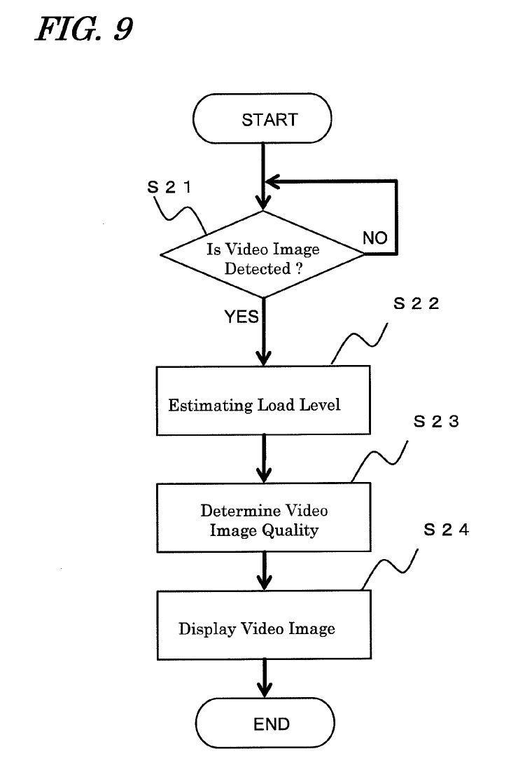

Description will be given in the flowchart of FIG. 9 for the processing of the display apparatus 31 concerning a case where, when the three video images are reproduced as shown in FIG. 8, the three video images are detected by the video image detecting portion.

Assume that a user is browsing the three video images like the display example shown in FIG. 8A with the display apparatus 31. At this time, when the video image detecting portion 36 detects distribution of the three video image data via the network 40 (YES at S21), a detected signal is transmitted to the load estimating portion 37. The load estimating portion 37 estimates, when receiving the video image detected signal, a level of a load applied to display of the video image in the display apparatus 31 by processing related to reproduction of the total of the six video images including the three current video images and the three additional video images (S22).

The video image display control portion 38 determines display quality and arrangement of the video image according to the load level estimated by the load estimating portion 37, and controls the video image displayed on the video image display portion 34 (S23). Here, when the load level is determined to, for example, “moderate”, the display quality comes to be “slow reproduction”, and the arrangement is, for example, the arrangement as shown in the display example of FIG. 8B. The video image display portion 34 displays the six video images with the video image quality and the arrangement controlled by the video image display control portion (S24), and the processing is finished.

In the present flow, all the video images 45 and 46 in the display example of FIG. 8B come to be performed in the slow reproduction. Note that, in the present embodiment, the video image quality is described to be “real time (actual time) reproduction”, “slow reproduction”, and “skip reproduction”, however, not limited thereto. When the load level is increased, a frame rate or resolution of all the video images may be reduced, a compression rate may be increased, or a size of the video image may be scaled down. Moreover, as described above, the change of the video image quality may be executed only for the video image other than one to which a user pays attention and the additional video image.

Note that, in the present embodiment, although description has been given for the display control function when a different video image from a video image currently being viewed is input, it is needless to say that a decrease in the number of video images (for example, a decrease from the six video images as the display example of FIG. 8B to the three video images as the display example of FIG. 8A) due to finishing of a part of the plurality of video images being displayed or the like is also detected by the video image detecting portion 36 shown in FIG. 7 so that the video image is displayed with an optimum video image quality at the time point according to the flowchart of FIG. 9. In this respect, same applies to other embodiments.

With this processing, in a case where an increase of a load related to the processing capacity of the device is expected due to an increase of the video image to be displayed, the display quality of a video image which is currently displayed and a video image to be added is changed, and display is thus able to be continued without interrupting or finishing the plurality of video images.

### Fourth Embodiment

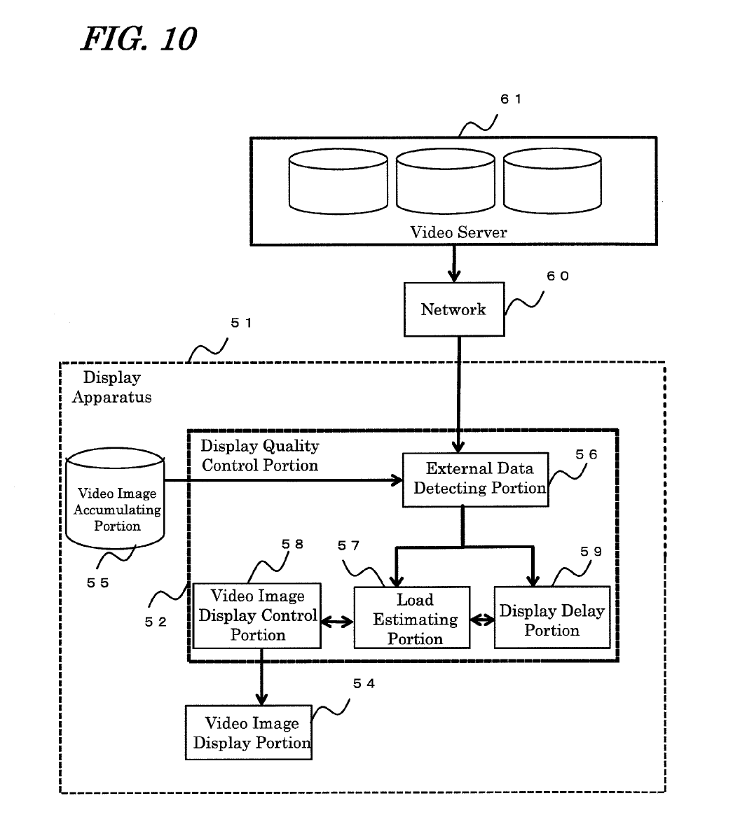

A configuration of a display apparatus in the fourth embodiment is shown in FIG. 10. The display apparatus 51 includes a display quality control portion 52, a video image display portion 54, as well as a video image accumulating portion 55. The display quality control portion 52 includes a video image detecting portion 56, a load estimating portion 57, a video image display control portion 38, and a display delay portion 59.

The fourth embodiment is comprised of, as shown in FIG. 10, in addition to the configuration of the third embodiment, the display delay portion (display delay means) 59. Thereby, when video image data which is distributed from the video server via the Net or video image data from the video image accumulating portion 55 is detected, display of the video image is delayed by a predetermined time, and meanwhile, a load applied to a CPU of the display apparatus 51 due to an increase of the number of video images is estimated and quality and arrangement of the video image display are controlled, and display is thus able to be continued without interrupting or finishing the video image reproduction even though the number of video image to be displayed increases.

Hereinafter, on the basis of FIG. 10, description will be given for each portion constituting the display apparatus 51.

(Function of Display Quality Control Portion)

The video image detecting portion (video image detecting means) 56 detects an input of video image data from a video image accumulating portion or from a video server via a network, and transmits a detected signal to the load estimating portion 57 and the display delay portion 59. The display delay portion (display delay means) 59 delays, when receiving the video image incoming detected signal, the processing of the detected video image, namely display (reproduction) of the video image by a predetermined time.

The load estimating portion (load estimating means) 57 estimates, when receiving the video image incoming detected signal, a level of a load applied to display of a plurality of video images currently being displayed by the processing related to the video image. The load at this time is a total load to a CPU of the display apparatus 51 that is estimated from a processing amount required for display of the current video image, a processing amount related to display of the additional video image and a processing amount related to video image data, and a battery remaining amount of the display apparatus 51. For example, in a case where, when three video images are displayed, different three video images are received, a load level of a CPU is estimated from the processing amount required for the reproduction processing for a total of six video images, the battery remaining amount of the display apparatus 51 and the like. Note that, the processing amount required for the display of the plurality of the video images depends on the number of pieces of video images displayed on the screen, a size of each video image, the number of frame rates, the resolution and the like.

The video image display control portion (video image display control means) 58 determines display quality of all the video images (the video image currently being displayed and the video image to be added) according to the load level estimated by the load estimating portion (load estimating means) 57, and controls reproduction of each thumbnail video image displayed on the screen at the video image display portion 54 (in the case of encoded data, decoding processing is included) and arrangement of the thumbnails on the screen. For example, when the load level is increased, a frame rate or resolution of all the video images is reduced, a compression rate is increased, or decoding processing is simplified. As a method for simplifying the decoding processing, simplification of motion compensation, omission of a deblocking filter, frame skip, and the like are included. As with the first embodiment, the display quality management table as shown in FIG. 4 is provided, and determination is made for the video image quality level to be any of real-time (actual time) reproduction, slow reproduction, or skip reproduction according to the load level estimated by the load estimating portion (load estimating means).

The video image display control portion (video image display control means) 58 may have a display timing control function so that all the plurality of video images are switched into the display quality simultaneously after delaying the display.

The video image display control portion (video image display control means) 58 may also perform change of the display quality only for a video image other than a video image to which a user pays attention. The video image to which a user pays attention is, for example, a video image on the display apparatus 51 on which a cursor or the like is placed, a video image which is displayed in the center of a screen of the display apparatus 51, or a video image which is selected by a user operation.

The video image display control portion (video image display control means) 58 may also have a function to perform change of the display quality only for an additional video image.

Additionally, the video image display control portion (video image display control means) 58 may have a function to give a notice to a user about a change in the display quality of a video image during delay of the display.

The video image display portion (video image display means) 54 is comprised of, for example, a liquid crystal panel, and displays as a thumbnail, after a predetermined (delay) time, the video image distributed via the Net and the video currently being displayed, with video image quality and an arrangement which have been determined in the video image display control portion 58.

(Processing Flow of Display Quality Control)

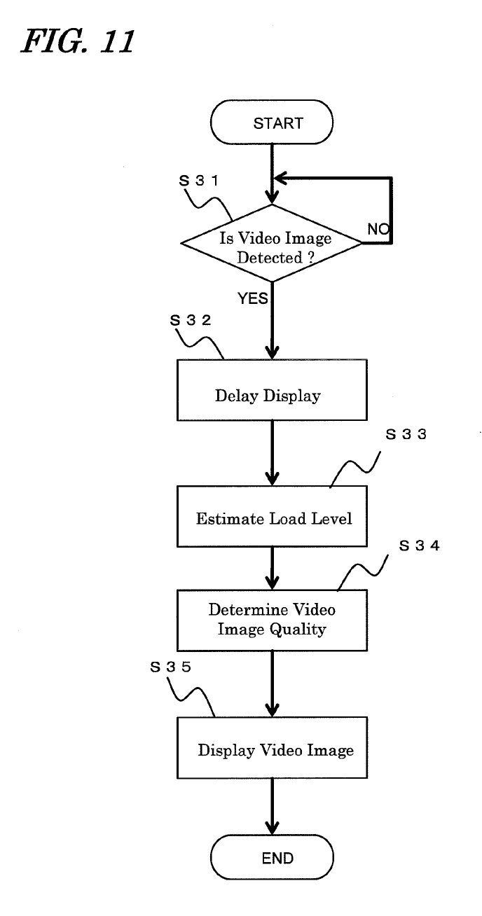

Description will be given in the flowchart of FIG. 11 for the processing of the display apparatus 51 concerning a case where, when the three video images are reproduced, the three video images are detected by the video image detecting portion 56.

Assume that a user is browsing the three video images like the display example shown in FIG. 8A with the display apparatus 51. At this time, when the video image detecting portion 56 detects distribution of the three video image data via the network 60 by a video server (YES at S31), an incoming detected signal is transmitted to the load estimating portion 57 and the display delay portion 59. The display delay portion 59 delays, when receiving the video image incoming detected signal, display of the video image by a predetermined time (S32). The load estimating portion 57 estimates, when receiving the video image incoming detected signal, a level of a load applied to display of the video image in the display apparatus 51 by processing related to reproduction of the total of the six video images including the three current video images and the three added video images (S33). Note that, in the processing flow, estimation of the load level is performed after delaying the display, however, the display may be delayed after estimating the load level, or those processing may be performed simultaneously.

The video image display control portion 58 determines display quality and arrangement of the video image according to the load level estimated by the load estimating portion 57, and controls the video image displayed on the video image display portion 34 (S34). Here, when the load level is determined to, for example, “moderate”, the display quality comes to be “slow reproduction”, and the arrangement is, for example, the arrangement as shown in the display example of FIG. 8B. The video image display portion 54 displays, after the elapse of a predetermined time, the six video images with the video image quality and the arrangement determined by the video image display control portion (S35), and the processing is finished.

Note that, in the present processing flow, the display delay at S32 is set to a predetermined time, and display execution at S35 is performed after the elapse of a predetermined time. However, without setting the time of the processing delay at S32, although not shown in FIG. 11, the delay time may be determined at S33 according to the load level estimated by the load estimating portion 57, or alternatively, a flow may be provided for judging whether or not the video image quality at S34 is determined, and the process may shift to the display execution at S35 when the video image quality is determined.

In this manner, in the fourth embodiment, the display delay portion 59 for an additional video image is provided and display of the video image distributed from the Net or a video image selected from the video image accumulating portion 55 is thereby delayed by a predetermined time, and meanwhile (before a CPU load increases), the display quality of the video image is changed, and display of a plurality of video images corresponding to the processing capacity of the device is thereby able to be performed, so that display of a video image is able to be continued without interrupting or finishing.

### Fifth Embodiment

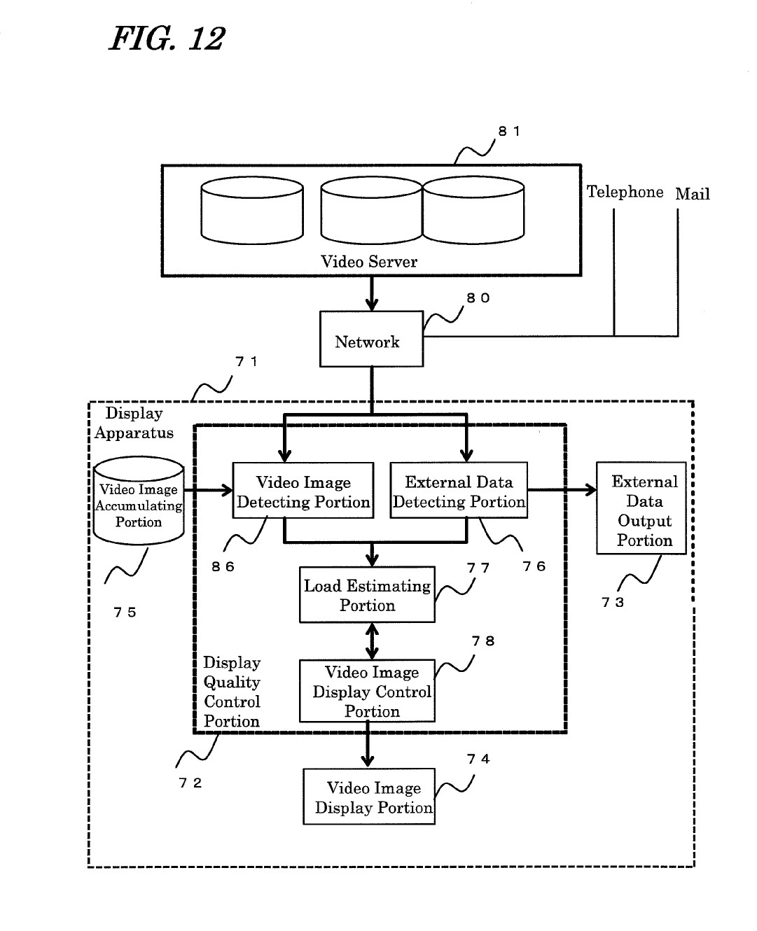

Hereinafter, description will be given for an embodiment of the present invention with using the drawings. As an embodiment, as with the first and the second embodiments, on the basis of a display apparatus 71 (FIG. 12) configured to be applied to a communication device such as a mobile phone, description will be given for each portion.

The display apparatus 71 includes a display quality control portion 72, an external data output portion 73, a video image display portion 74, as well as a video image accumulating portion 75. The display quality control portion 72 includes an external data detecting portion 76, a video image detecting portion 86, a load estimating portion 77 and a video image display control portion 78.

In the fifth embodiment, the first embodiment and the third embodiment coexist, and which makes it possible to process both the external data such as an incoming call or mail, and a video image of the video image accumulating portion 75 which is incorporated in the display apparatus 71 and a video image distributed via the Net.

Thereby, when a plurality of video images are displayed on one screen, in addition to the external data such as an incoming call, even when video image data is received from the video image accumulating portion 75 or a video server 81 via a network 80, the display of the video image is able to be continued without interrupting or finishing reproduction thereof.

The load estimating portion 77 in the display quality control portion 72 estimates the load related to both the processing of the external data described in the first embodiment and the video image described in the second embodiment, and the video image display control portion 78 controls, when the external data such as the incoming call is input and/or video image data is added to a video image currently being displayed from the video image accumulating portion 75 and/or the video server 81, so that the display quality of the video image displayed on the screen is changed so as not to exceed the processing capacity of the display apparatus 71, and enables the plurality of video images to be continued to be displayed without interrupting or finishing reproduction thereof.

(Function of Display Quality Control Portion)

The external data detecting portion (external data detecting means) 76 detects an input of external data such as an incoming call or mail via a communication function to the display apparatus 71, and transmits a detected signal to the load estimating portion 77. The video image detecting portion (video image detecting means) 86 detects distribution of a plurality of video images via the Net from the video image accumulating portion 75 and the video server 81, and transmits a detected signal to the load estimating portion 77. The load estimating portion (load estimating means) 77 estimates, when receiving the incoming detected signal of the external data and/or the video image data, a level of a load applied to display of a plurality of video images currently being displayed by the processing related to the external data and/or the video image data. The load at this time is a total load to a CPU of the display apparatus 71 that is estimated from a processing amount required for display of the current video image, a processing amount related to the external data and/or the video image data, and a battery remaining amount of the display apparatus 71.

The video image display control portion (video image display control means) 78 determines display quality of all the video images (the video image currently being displayed and the video image to be added) according to the load level estimated by the load estimating portion (load estimating means) 77, and controls reproduction of each thumbnail video image displayed on the screen at the video image display portion 74 (in the case of encoded data, decoding processing is included) and arrangement of the thumbnails on the screen. For example, when the load level is increased, a frame rate or resolution of all the video images is reduced, a compression rate is increased, or decoding processing is simplified. As a method for simplifying the decoding processing, simplification of motion compensation, omission of a deblocking filter, frame skip, and the like are included. In the fifth embodiment, as with the first embodiment, the display quality management table 15 as shown in FIG. 4 is provided, and the video image quality level 17 is determined to be any of real-time (actual time) reproduction, slow reproduction, or skip reproduction according to the load level 16 estimated by the load estimating portion (load estimating means) 77. The detail thereof is the same as the above described embodiments.

The video image display control portion (video image display control means) 78 may also have a function to perform change of the display quality only for a video image other than a video image to which a user pays attention. Further, the video image display control portion (video image display control means) 78 may have a function to perform change of the display quality only for an additional video image.

The video image display portion (video image display means) 74 is comprised of, for example, a liquid crystal panel, and displays as a thumbnail the video images currently being displayed and the additional video image, with video image quality and an arrangement which have been determined in the video image display control portion.

The external data output portion (external data output means) 73 executes processing of external data (for example, ringing or the like in the case of the incoming call processing).

(Processing Flow of Display Quality Control)

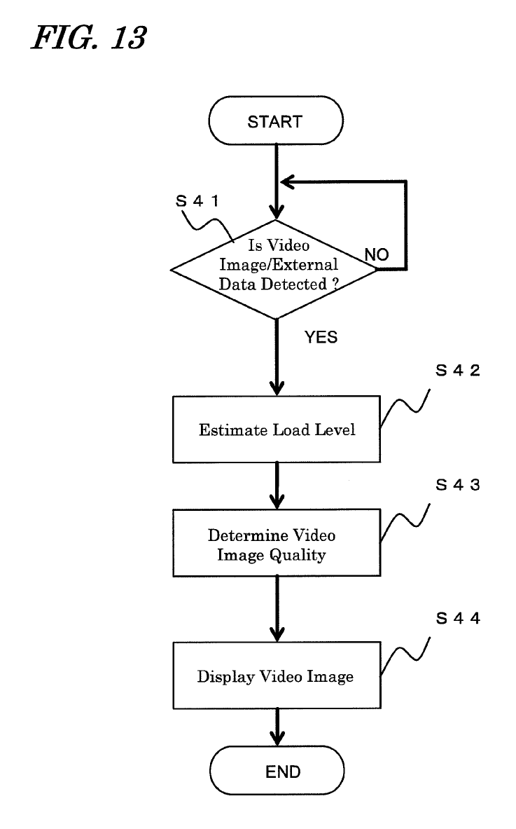

Description will be given in the flowchart of FIG. 13 for the processing flow of the display apparatus 71 in the fifth embodiment.

Assume that a user is browsing the three video images like the display example shown in FIG. 8A with the display apparatus 71. At this time, when the video image data detecting portion 86 detects distribution of the three video image data via the network 80, an incoming detected signal is transmitted to the load estimating portion 77. On the other hand, when the external data detecting portion 76 detects external data such as an incoming call, the incoming detected signal is transmitted to the load estimating portion 77. That is, when the video image data detecting portion 86 and/or the external data detecting portion 76 detects the video image data and/or external data, an incoming detected signal is transmitted to the load estimating portion 77 (YES at S41).

The load estimating portion 77 estimates a level of a load applied to display of the video image in the display apparatus 71 by reproduction of the total of the six video images including the three current video images and the three added video images and processing of the external data (S42). The video image display control portion 78 determines display quality and arrangement of the video image according to the load level estimated by the load estimating portion 77, and controls the video image displayed on the video image display portion 74 (S43). Here, when the load level is determined to, for example, “large”, the display quality comes to be “skip reproduction”, and the arrangement is, for example, the arrangement as shown in the display example of FIG. 8B. The video image display portion 74 displays the six video images with the video image quality and the arrangement determined by the video image display control portion 78 (S44), and the processing is finished.

With this processing, in a case where an increase of a load related to the processing capacity of the device is predicted due to an increase of the video image to be displayed and having a phone call, the display quality of the video image currently being displayed and the video image to be added is changed so as not to exceed the processing capacity of the display apparatus 71, and enables the plurality of video images to be continued to be displayed without interrupting or finishing reproduction thereof.

### Sixth Embodiment

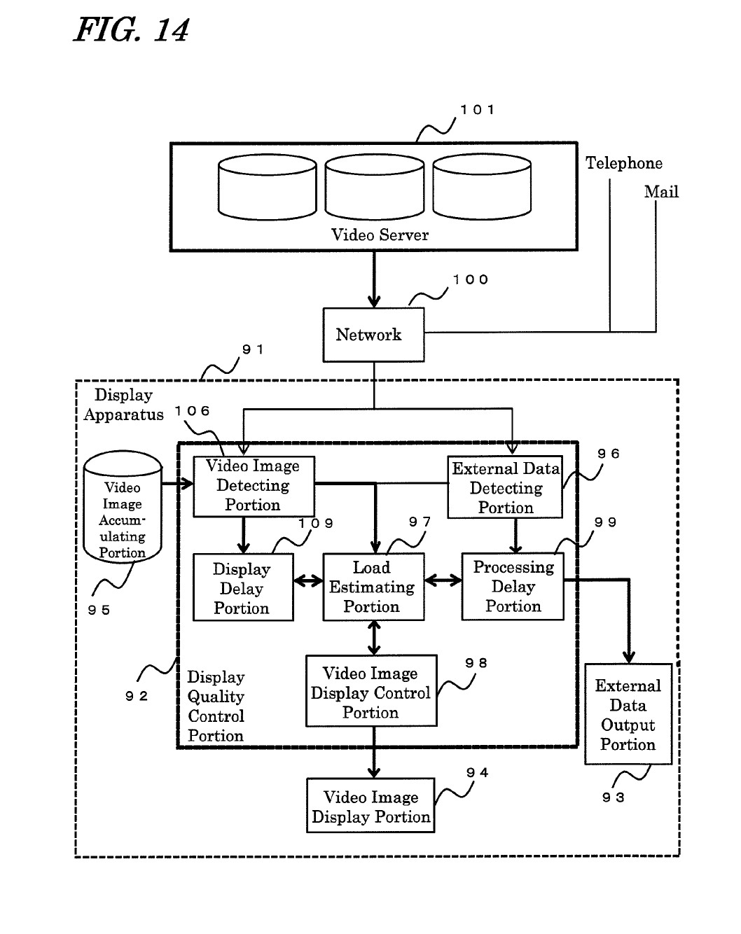

A configuration of a display apparatus 91 in the sixth embodiment is shown in FIG. 14. The display apparatus 91 includes a display quality control portion 92, an external data output portion 93, a video image display portion 94, as well as a video image accumulating portion 95. The display quality control portion 92 includes an external data detecting portion 96, a video image detecting portion 106, a processing delay portion 99, a display delay portion 109, a load estimating portion 97 and a video image display control portion 98.

In the sixth embodiment, as shown in FIG. 14, it is characterized in that in addition to the configuration of the fifth embodiment, a display delay portion (display delay means) 109 and a processing delay portion (processing delay means) 99 are provided in the display quality control portion 92. Thereby, at the time of displaying a plurality of video images on a screen, when a video image is received from the video image accumulating portion 95 or a video server 101 via a network 100, adding to the external data such as an incoming call, processing of the external data and display of the video image is delayed by a predetermined time, and meanwhile, a load applied to a CPU of the device is estimated, and quality and arrangement of the video image display are controlled, and display of the video image is thereby able to be continued without interrupting or finishing reproduction thereof.

Hereinafter, on the basis of FIG. 14, description will be given for each portion constituting the display apparatus 91.

(Function of Display Quality Control Portion)

The external data detecting portion (external data detecting means) 96 detects an input of external data such as an incoming call or mail to the display apparatus 91 via a communication function. For example, when detecting an incoming call, an incoming detected signal is transmitted to the processing delay portion 99 and the load estimating portion 97. The video image detecting portion (video image detecting means) 106 detects distribution of video image data from the video image accumulating portion 95 or from a video server 101 via the Net, and transmits a detected signal to the display delay portion 109 and the load estimating portion 97.

The processing delay portion (processing delay means) 99 delays, when receiving the external data incoming detected signal, the processing of the external data (such as ringing in the case of an incoming call) by a predetermined time. The display delay portion (display delay means) 109 delays, when receiving the video image reception signal, the processing of the video image by a predetermined time. The processing of the video image is, for example, reproduction processing of a distributed video image.

The load estimating portion (load estimating means) 97 estimates, when receiving the external data and/or the video image incoming detected signal, a level of a load applied to display of a plurality of video images currently being displayed by the processing related to the external data and/or the video image data. The load at this time is a total load to a CPU of the display apparatus 91 that is estimated from a processing amount required for display of the current video image, a processing amount related to the external data and/or the video image data, and a battery remaining amount of the display apparatus 91.

The video image display control portion (video image display control means) 98 determines display quality of all the video images (the video image currently being displayed and the video image to be added) according to the load level estimated by the load estimating portion (load estimating means) 97, and controls reproduction of each thumbnail video image displayed on the screen at the video image display portion 94 (in the case of encoded data, decoding processing is included) and arrangement of the thumbnails on the screen. For example, when the load level is increased, a frame rate or resolution of all the video images is reduced, a compression rate is increased, or decoding processing is simplified. As a method for simplifying the decoding processing, simplification of motion compensation, omission of a deblocking filter, frame skip, and the like are included. The detail thereof is the same as the above-described embodiments.

The video image display control portion (video image display control means) 98 may also have a display timing control function so that all the plurality of video images are switched into the display quality simultaneously after the elapse (delay) of a predetermined time.

The video image display control portion (video image display control means) 98 may also perform change of the display quality only for a video image other than a video image to which a user pays attention.

The video image display control portion (video image display control means) 98 may also have a function to execute change of the display quality only for an additional video image.

Additionally, the video image display control portion (video image display control means) 98 may have a function to give a notice to a user about a change in the display quality of a video image during delay of the display.

The video image display portion (video image display means) 94 is comprised of, for example, a liquid crystal panel, and displays as a thumbnail all the video images with video image quality and an arrangement which have been determined in the video image display control portion.

The external data output portion (external data output means) 93 executes processing of external data (for example, processing such as ringing in the case of the incoming call processing) which has been delayed in the processing delay portion 99.

(Processing Flow of Display Quality Control)

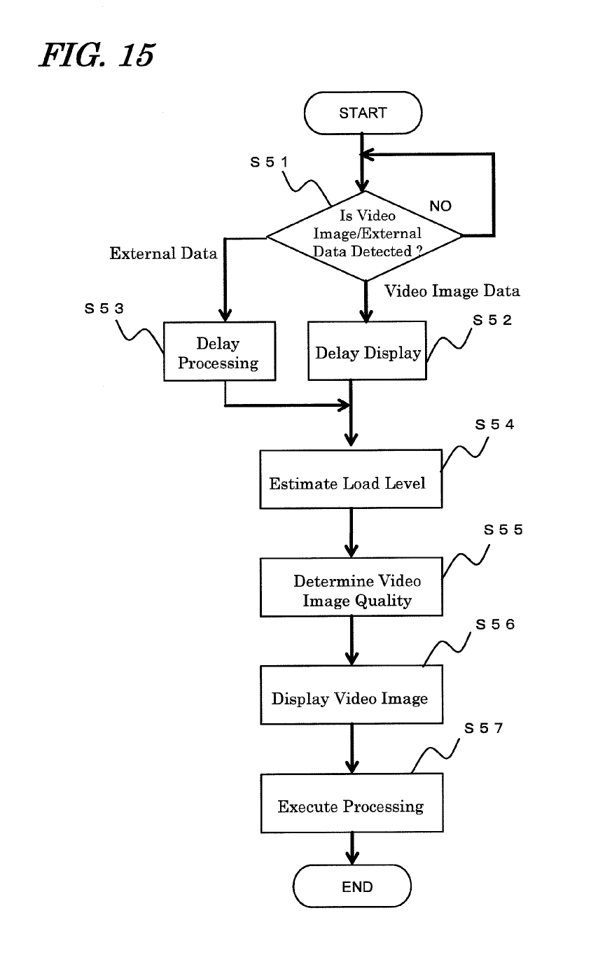

Description will be given in the flowchart of FIG. 15 for the processing flow of the display apparatus 91 in the sixth embodiment.

Assume that a user is browsing the three video images like the display example shown in FIG. 8A with the display apparatus 91. At this time, when the video image detecting portion 106 detects distribution of the three video image data from the video image accumulating portion 95 or from a video server 101 via the network 100, an incoming detected signal is transmitted to the display delay portion 109 and the load estimating portion (video image data at S51). On the other hand, when the external data detecting portion 96 detects external data such as in incoming call, an incoming detected signal is transmitted to the processing delay portion 99 and the load estimating portion 97 (external data at S51). That is, the video image detecting portion 106 and/or the external data detecting portion 96 detects the video image data and/or the external data, the incoming detected signal is transmitted to the load estimating portion 97.

The display delay portion 109 delays, when receiving the video image incoming detected signal, display of the video image by a predetermined time (S52). The processing delay portion 99 delays, when receiving the external data incoming detected signal, the processing of the data (such as ringing) by a predetermined time (S53). The load estimating portion 97 estimates, when receiving the external data and/or the video image incoming detected signal, a level of a load applied to display of the video image in the display apparatus 91 by processing of reproduction of the total of the six video images including the three current video images and the three added video images and the processing of the external data (S54). Note that, in the processing flow, the processing is performed in the order of the display delay, the processing delay, and the estimation of the load level, however, the processing order may be interchanged, or two or three processing may be performed simultaneously.

The video image display control portion 98 determines display quality and arrangement of the video image according to the load level estimated by the load estimating portion 97, and controls the video image displayed on the video image display portion 94 (S55). Here, when the load level is determined to, for example, “large”, the display quality comes to be “skip reproduction”, and the arrangement is, for example, the arrangement as shown in the display example of FIG. 8B. The video image display portion 94 displays, after the elapse of a predetermined time, the six video images with the video image quality and the arrangement determined by the video image display control portion 98 (S56). After the elapse of a predetermined time, the external data output portion 93 executes processing of the external data such as incoming call processing (such as ringing) (S57), and the processing is finished.

In this manner, in the sixth embodiment, the display delay portion and the processing delay portion are provided, and the quality and arrangement of the plurality of video images are controlled before an increase of a CPU load due to an increase of the video image to be displayed and having a phone call and the like, so as to make it possible to continue display of the video image without interrupting or finishing.

Furthermore, the function of the display quality control portion according to above-described each embodiment is able to be realized by a computer. In such a case, a program in which such a functional processing content is described is provided. By executing the program in the computer, the above-described processing is then realized on the computer. The program in which the processing content is described is able to be recorded in a computer-readable recording medium.

### EXPLANATIONS OF NUMERALS

1, 21, 31, 51, 71, 91 display apparatus
2, 22, 32, 52, 72, 92 display quality control portion
3, 23, 73, 93 external data output portion
4, 24, 34, 54, 74, 94 video image display portion
5, 25, 35, 55, 75, 95 video image accumulating portion
6, 26, 76, 96 external data detecting portion
7, 27, 37, 57, 77, 97 load estimating portion
8, 28, 38, 58, 78, 98 video image display control portion
10, 30, 40, 60, 80, 100 network
15 display quality management table
29, 99 processing delay portion
41, 61, 81, 101 video server
59, 109 display delay portion
36, 56, 86, 106 video image detecting portion

1. A display apparatus for controlling display quality of a plurality of video image data to be displayed, comprising:
data detecting means for detecting an input of data different from video image data being displayed;
load estimating means for estimating a load applied to a processing capacity of the display apparatus by the different data; and
video image display control means for changing, in a case where the load exceeds the processing capacity of the display apparatus, quality of a plurality of video images to be displayed on the display apparatus so that display processing is able to be continued.

2. The display apparatus according to claim 1, wherein the different data is external data which is data other than the video image.

3. The display apparatus according to claim 2, further comprising processing delay means for delaying processing of the external data by a predetermined time when reception of the external data is detected by the data detecting means.

4. The display apparatus according to claim 1, wherein the different data is different video image data which is displayed additionally to the display video image data.

5. The display apparatus according to claim 4, further comprising processing delay means for delaying processing of the different video image data by a predetermined time when reception of the different video image data is detected by the data detecting means.

6. A display apparatus for controlling display quality of a plurality of video image data to be displayed, comprising:
video image detecting means for detecting video image data which is displayed additionally to display video image data;
external data detecting means for detecting an input of external data which is data different from the video image data;
load estimating means for estimating a load applied to display of a plurality of video images displayed on the display apparatus by the additional video image data and/or the external data; and
video image display control means for changing, in a case where the load exceeds the processing capacity of the display apparatus, quality of a video image to be displayed so that display processing is able to be continued.

7. The display apparatus according to claim 6, further comprising:
display delay means for delaying, when an input of the additional video image is detected by the video image detecting means, display of the additional video image by a predetermined time; and
processing delay means for delaying, when reception of the external data is detected by the external data detecting means, processing of the external data by a predetermined time.

8. The display apparatus according to claim 1, wherein the video image display control means changes the display quality by switching into real-time reproduction, slow reproduction, or skip reproduction according to a load level estimated by the load estimating means.

9. The display apparatus according to claim 1, wherein the video image display control means changes the display quality by simplifying decoding processing within an allowable range of image quality deterioration according to a load level estimated by the load estimating means.

10. The display apparatus according to claim 1, wherein the video image display control means switches the display quality of all the video images simultaneously.

11. The display apparatus according to claim 1, wherein the video image display control means changes the display quality for a video image other than a video image to which a user pays attention.

12. The display apparatus according to claim 1, wherein the video image display control means changes the display quality only for a video image which is newly added.

13. The display apparatus according to claim 3, wherein the video image display control means has a function to give a notice to a user about a change in the display quality of a video image during delay.

14. A display method for controlling display quality of a plurality of video image data to be displayed on a display apparatus, comprising:
a data detecting step of detecting an input of data different from video image data being displayed;
a load estimating step of estimating a load applied to a processing capacity of the display apparatus by the different data; and
a video image display control step of changing, in a case where the load exceeds the processing capacity of the display apparatus, quality of a plurality of video images to be displayed on the display apparatus so that display processing is able to be continued.

15. The display method according to claim 14, wherein the different data is external data which is data other than the video image.

16. The display method according to claim 15, further comprising a processing delay step of delaying, when reception of the external data is detected at the data detecting step, processing of the external data by a predetermined time.

17. The display method according to claim 14, wherein the different data is different video image data which is displayed additionally to display video image data.

18. The display method according to claim 17, further comprising a processing delay step of delaying, when reception of the different video image data is detected at the data detecting step, processing of the different video image data by a predetermined time.

19. A display method for controlling display quality of a plurality of video image data to be displayed, comprising:
a video image detecting step of detecting video image data which is displayed additionally to display video image data;
an external data detecting step of detecting an input of external data different from the video image data;
a load estimating step of estimating a load applied to display of a plurality of video images displayed on the display apparatus by the additional video image data and/or the external data; and
a video image display control step of changing, in a case where the load exceeds the processing capacity of the display apparatus, quality of a video image to be displayed so that display processing is able to be continued.

20. The display method according to claim 19, further comprising:
a display delay step of delaying, when an input of the additional video image is detected by the video image detecting step, display of the additional video image by a predetermined time; and
a processing delay step of delaying, when reception of the external data is detected at the external data detecting step, processing of the external data by a predetermined time.

21. The display method according to claim 14, wherein at the video image display control step, the display quality is changed by switching into real-time reproduction, slow reproduction, or skip reproduction according to a load level estimated by the load estimating means.

22. The display method according to claim 14, wherein at the video image display control step, the display quality is changed by simplifying decoding processing within an allowable range of image quality deterioration according to a load level estimated by the load estimating means.

23. The display method according to claim 14, wherein at the video image display control step, the display quality of all the video images is switched simultaneously.

24. The display method according to claim 14, wherein at the video image display control step, the display quality is changed for a video image other than a video image to which a user pays attention.

25. The display method according to claim 14, wherein at the video image display control step, the display quality is changed only for a video image which is newly added.

26. The display method according to claim 16, wherein at the video image display control step, a function to give a notice to a user about a change in the display quality of a video image during delay is provided.

27. A program for causing a computer to execute the display method according to claim 14.
